(19) United States
(12) Patent Application Publication
(10) Pub. No.: US 2025/0229687 A1
(43) Pub. Date: Jul. 17, 2025

(54) MULTI-CHANNEL VEHICLE-MOUNTED SEAT VIBRATION FEEDBACK SYSTEM AND METHOD, AND RELATED DEVICE

(71) Applicant: AAC Acoustic Technologies (Shanghai) Co., Ltd., Shanghai (CN)

(72) Inventors: Xueni Cao, Shanghai (CN); Lijin Zhang, Shanghai (CN); Xiuyue Wang, Shanghai (CN); Yanxin Zhang, Shanghai (CN); Yajun Zheng, Shanghai (CN)

(21) Appl. No.: 18/797,488

(22) Filed: Aug. 7, 2024

Related U.S. Application Data
(63) Continuation of application No. PCT/CN2024/072444, filed on Jan. 16, 2024.

(51) Int. Cl. B60N 2/90; B60Q 9/00; H04R 5/02; H04S 3/00

(52) U.S. Cl. CPC B60N 2/90; H04R 5/023; H04S 3/008; B60N 2002/981; B60Q 9/00; H04R 2499/13; H04S 2400/01

(57) ABSTRACT

A multi-channel vehicle-mounted seat vibration feedback system and method, the system includes a signal input module configured for obtaining interaction signals collected or output by an automobile system; a signal processing module configured for performing data stream conversion on each interaction signal to obtain a corresponding pending signal; a multi-channel data processing module configured for preprocessing the pending signal according to a preset signal processing method to obtain a multi-channel signal; a driving module configured for outputting a driving signal for driving the vibration and/or sound of the automobile seat through a feedback output channel according to the multi-channel signal; and an execution module configured for driving the vibration and/or sound of an actuator of the automobile seat according to the driving signal output by each individual tactile feedback output channel. As a result, the signal feedback effect is more accurate and richer, and the use experience is better.

### TECHNICAL FIELD

The present disclosure relates to a vibration feedback system, in particular, to a multi-channel vehicle-mounted seat vibration feedback system and method, and a related device.

### BACKGROUND

A multifunctional automobile seat has integrated a vibration function and a sounding function, and vibration feedback of the automobile seat is a better manner of transmitting takeover information, which may improve quality and safety of human-computer interaction.

In the related art, a driver in an automatic driving state may perform various non-driving related tasks (NDRTs), and these non-driving related tasks occupy sensory channels such as vision and hearing of the driver, so that the driver is distracted. In such cases, feedback such as visual and auditory takeover reminders during driving may be ignored by the driver. However, if the seat may generate vibration feedback, the driver sitting on the driver's seat may always obtain vibration information from the seat, so that the driver will not easily miss tactile feedback.

However, the existing automobile seat tactile feedback technology is limited in application, and essentially lacks an effective tactile feedback technical solution.

Therefore, it is necessary to provide a new vehicle-mounted seat vibration feedback system to solve the above problems.

### SUMMARY

The technical problem to be solved by the present disclosure is to provide a multi-channel vehicle-mounted seat vibration feedback system and method and a related device with more accurate vibration and sound feedback effects.

In order to solve the above technical problem, in a first aspect, the present disclosure provides a multi-channel vehicle-mounted seat vibration feedback system, including: a signal input module, configured to obtain at least one interaction signal collected or output by an automobile system; a signal processing module, configured to perform data stream conversion on each interaction signal to obtain a corresponding pending signal; a multi-channel data processing module, configured to preprocess the pending signal according to a preset signal processing method to obtain a multi-channel signal; a driving module, configured to output, through at least one feedback output channel, a driving signal for driving vibration and/or sound of an actuator mounted on an automobile seat according to the multi-channel signal; and an execution module, configured to drive the vibration and/or sound of the actuator according to the driving signal output by each individual feedback output channel. The actuator is at least one of a vibration motor and a speaker.

As an improvement, the signal processing module is further configured to: identify and analyze the interaction signal by using a preset machine learning algorithm, and separate a single interaction signal into a plurality of signals having different features, each of the signals having different features is used as a new interaction signal to perform data stream conversion processing.

As an improvement, the multi-channel data processing module is configured to: allocate the pending signal corresponding to the interaction signal to different signal channels according to preset interactive scenarios corresponding to different interaction signals, to obtain the multi-channel signal.

As an improvement, each of the signal channels corresponds to at least one of the feedback output channels, and each of the feedback output channels corresponds to an individual actuator of the automobile seat.

As an improvement, the driving module is further configured to: perform digital amplification processing on the driving signal according to vibration acoustic characteristics of the automobile seat.

As an improvement, the preset signal processing method comprises at least one of signal sampling, signal encoding and decoding, signal noise reduction, signal filtering, and calling from a preset database according to signal type.

As an improvement, the preset machine learning algorithm comprises at least one of a sound feature extraction and classification algorithm, an image feature extraction and classification algorithm, a sound-based supervised and unsupervised machine learning algorithm, and an image-based supervised and unsupervised machine learning algorithm.

In a second aspect, the present disclosure further provides a multi-channel vehicle-mounted seat vibration feedback method, including the following steps: obtaining at least one interaction signal collected or output by an automobile system; performing data stream conversion on each interaction signal to obtain a corresponding pending signal; preprocessing the pending signal according to a preset signal processing method to obtain a multi-channel signal; outputting, through at least one feedback output channel, a driving signal for driving the vibration and/or sound of an actuator mounted on an automobile seat according to the multi-channel signal; and driving the vibration and/or sound of the actuator according to the driving signal output by each individual feedback output channel. The actuator includes at least one of a vibration motor and a speaker.

In a third aspect, the present disclosure further provides a computer device, including: a memory, a processor, and a multi-channel vehicle-mounted seat vibration feedback program stored on the memory and executable on the processor. The processor implements the steps of the multi-channel vehicle-mounted seat vibration feedback method as described above when executing the multi-channel vehicle-mounted seat vibration feedback program.

In a fourth aspect, the present disclosure further provides a non-transitory computer-readable storage medium, a multi-channel vehicle-mounted seat vibration feedback program is stored on the computer-readable storage medium, and when the multi-channel vehicle-mounted seat vibration feedback program is executed by a processor, steps of the multi-channel vehicle-mounted seat vibration feedback method as described above are implemented.

Compared with the related art, in the present disclosure, a multi-channel vehicle-mounted seat vibration feedback system includes a signal input module which is used for obtaining at least one interaction signal collected or output by an automobile system; a signal processing module which is used for performing data stream conversion on each interaction signal to obtain a corresponding pending signal; a multi-channel data processing module which is used for preprocessing the pending signal according to a preset signal processing method to obtain a multi-channel signal; a driving module which is used for outputting a driving signal used for driving the vibration and/or sound of the automobile seat through at least one feedback output channel according to the multi-channel signal; and an execution module which is used for driving the vibration and/or sound of the automobile seat according to the driving signal of each individual tactile feedback and audio output channel. Based on the characteristics of the multifunctional automobile seat, multi-channel driving signals are generated for different interaction scenarios between the automobile and drivers and passengers, and the vibration and sound production control of the multifunctional automobile seat is implemented in a mode of independently controlling an output channel, so that the feedback of the signals to the drivers and the passengers is more accurate and richer, and thus the use experience is improved.

### BRIEF DESCRIPTION OF DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference signs designate corresponding parts throughout the several views.

FIG. 1 is a schematic structural diagram of a multi-channel vehicle-mounted seat vibration feedback system according to an embodiment of the present disclosure;

FIG. 2 is a schematic diagram of vibration of a multi-channel vehicle-mounted seat vibration feedback system in a navigation scenario according to an embodiment of the present disclosure;

FIG. 3 is a schematic diagram of vibration of a multi-channel vehicle-mounted seat vibration feedback system in an obstacle avoidance scenario according to an embodiment of the present disclosure;

FIG. 4 is a schematic flowchart of steps of a multi-channel vehicle-mounted seat vibration feedback method according to an embodiment of the present disclosure; and

FIG. 5 is a schematic structural diagram of a computer device according to an embodiment of the present disclosure.

### DESCRIPTION OF EMBODIMENTS

Technical solutions in embodiments of the present disclosure will be described clearly and completely below in connection with the drawings in the present disclosure, and it will be apparent that the embodiments described here are only some of the embodiments of the present disclosure, not all of them. All other embodiments obtained by those skilled in the art based on the embodiments of the present disclosure without creative efforts should fall within the protection scope of the present disclosure.

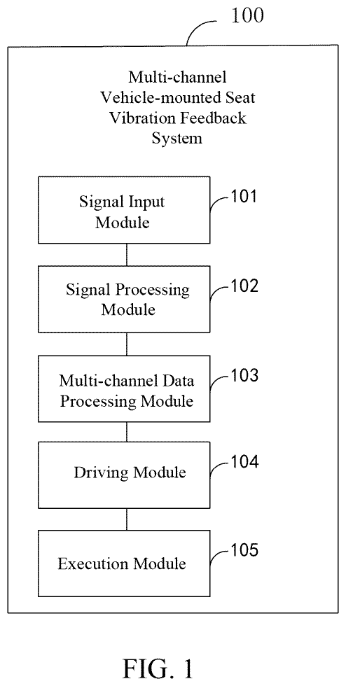

Referring to FIG. 1, FIG. 1 is a schematic structural diagram of a multi-channel vehicle-mounted seat vibration feedback system according to an embodiment of the present disclosure. The structure of the multi-channel vehicle-mounted seat vibration feedback system 100 includes: a signal input module 101, configured to obtain at least one interaction signal collected or output by an automobile system; a signal processing module 102, configured to perform data stream conversion on each interaction signal to obtain a corresponding pending signal; a multi-channel data processing module 103, configured to preprocess the pending signal according to a preset signal processing method to obtain a multi-channel signal; a driving module 104, configured to output a driving signal for driving the vibration and/or sound of an actuator mounted on an automobile seat through at least one feedback output channel according to the multi-channel signal; and an execution module 105, configured to drive the vibration and/or sound of the actuator according to the driving signal output by each individual feedback output channel. The actuator includes at least one of a vibration motor and a speaker.

In some embodiments, the signal processing module 102 is further configured to: identify and analyze the interaction signal by using a preset machine learning algorithm, and separate a single interaction signal into a plurality of signals having different signal features. Each signal having different features is used as a new interaction signal to perform data stream conversion processing.

The interaction signal in the embodiments of the present disclosure refers to a digital signal generated during interaction between the automobile system and a driver and between the automobile system and a passenger, or a digital signal collected by the automobile system through a sensor, a camera and other devices. These signals may various according to different application scenarios, including but not limited to a navigation instruction, a sensor signal, a voice signal, etc., and may be determined as required during implementation.

The preset machine learning algorithm includes at least one of a sound feature extraction and classification algorithm, an image feature extraction and classification algorithm, a sound-based supervised and unsupervised machine learning algorithm, and an image-based supervised and unsupervised machine learning algorithm. The signal processing module 102 may be implemented based on a processor unit having a certain computing power, and considering that all existing automobile systems are equipped with computer-based control centers, the signal processing module 102 may be implemented based on the existing control centers.

The preset machine learning algorithm may be integrated into a control center of an automobile and called by a processor unit to perform signal processing. For different types of interaction signals, different preset machine learning algorithms may be called for processing. For example, signals of sound and vibration may be processed by using different preset machine learning algorithms, thereby highlighting signal features thereof.

The multi-channel data processing module 103 is configured to: allocate the pending signal corresponding to the interaction signal to different signal channels according to preset interactive scenarios corresponding to different interaction signals, to obtain the multi-channel signal.

During implementation, the multi-channel data processing module 103 may be implemented based on a multi-channel sound card apparatus. Correspondingly, the pending signal output by the signal processing module 102 is required to be a signal that may be identified by the multi-channel sound card apparatus, for example, an audio and video data stream. The multi-channel data processing module 103 processes the pending signal by using the preset signal processing method. The processing method includes at least one of signal sampling, signal encoding and decoding, signal noise reduction, signal filtering, and at least one of items called from the preset database according to the signal type.

In some embodiments, the multi-channel signal is actually a signal obtained after a plurality of different interaction signals are converted and fused in different signal channels. That is, the multi-channel signal integrates the characteristics of a plurality of interactive signals.

Each of the signal channels corresponds to at least one of the feedback output channels, and each of the feedback output channels corresponds to an individual actuator of the automobile seat.

The automobile seat in embodiments of the present disclosure refers to a multifunctional automobile seat as mentioned in the background art, which is at least provided with a vibration motor and/or a speaker, and has vibrating function through the vibration motor and sounding function through the speaker, and the execution unit may be implemented based on these vibration motors and speakers during implementation. The feedback output channel is a data transmission channel between the driving module 104 and the execution module 105, and each of the feedback output channels corresponds to a vibration motor or a speaker of an individual automobile seat. According to the type of the corresponding actuator, during implementation, the feedback output channel may be modified into tactile feedback output channel and audio feedback output channel. Generally, in order to improve vibration and sounding effects, a plurality of vibration motors and speakers are integrated in the automobile seat, and the positions of the vibration motors and the speakers are distributed at different positions according to the shape of the seat. When the vibration motors and speakers at different positions generate vibration or sound, the corresponding prompts and contents for the driver are also different. In embodiments of the present disclosure, each of the feedback output channels corresponds to an individual vibration motor or speaker of the automobile seat, the purpose is to drive different vibration motors or speakers according to different specific interaction signals, thereby generating specific feedback.

The driving module 104 is further configured to: perform digital amplification processing on the driving signal according to the vibration acoustic characteristics of the automobile seat.

For ease of understanding, the following explains the use process of the multi-channel vehicle-mounted seat vibration feedback system 100 for different automobile interaction scenarios.

First, in a navigation scenario, an effect generated by the multi-channel vehicle-mounted seat vibration feedback system 100 may be to transmit navigation, driving and other information to a driver through seat vibration.

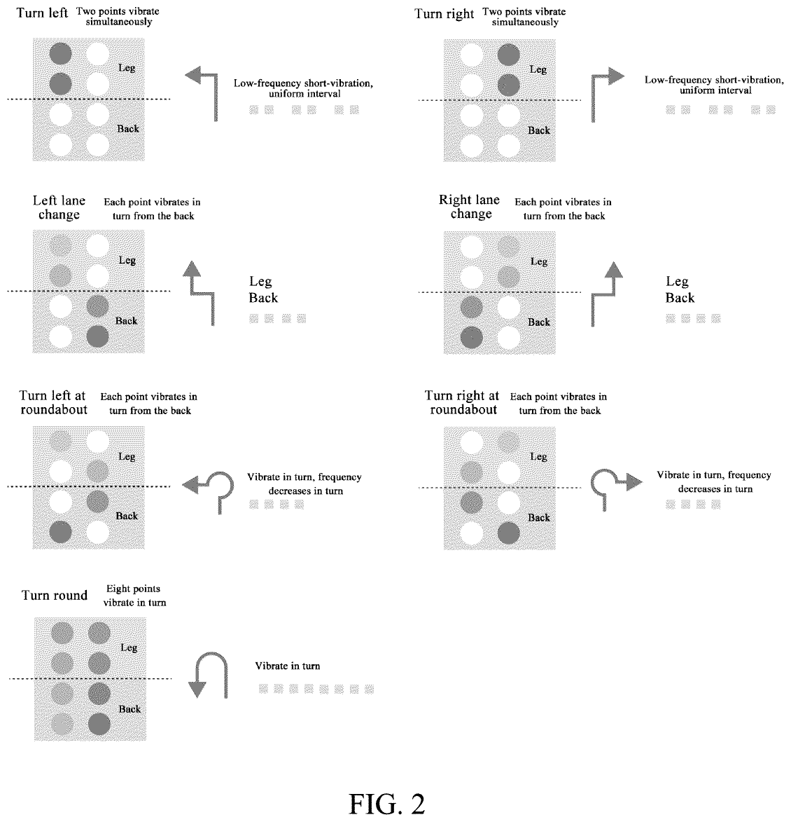

In situations such as left and right turning, left and right changing lanes, automobile approaching, FIG. 2 describes an embodiment of distinguishing different navigation situations by simultaneously or sequentially vibrating different vibration motors when the automobile seat includes 8 vibration motors and may generate vibration respectively. In this embodiment, the interaction signal is a navigation instruction generated by the navigation system, and different navigation instructions are processed by the multi-channel data processing module 103 to obtain the multi-channel signals including different vibration effects. A vibration effect in each signal channel corresponds to a vibration motor of one of the automobile seats through the feedback output channel, so that each vibration motor in the automobile seat may be individually controlled.

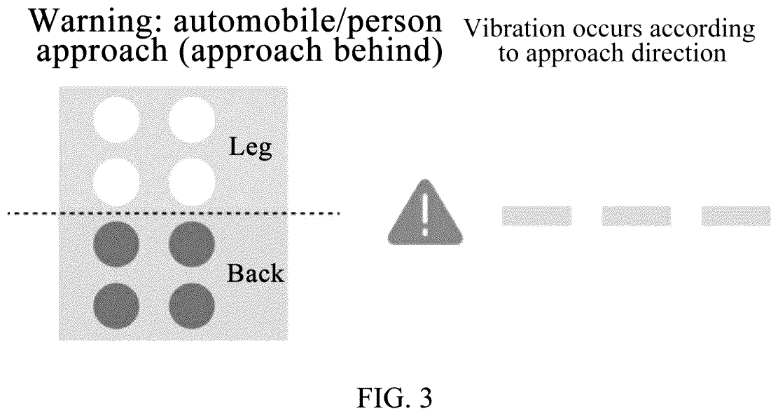

When a person, an automobile or other obstacle approaches, FIG. 3 describes an embodiment of distinguishing different obstacle orientations by simultaneously or sequentially vibrating different vibration motors when the automobile seat includes 8 vibration motors and may generate vibration respectively. In this embodiment, the interaction signal is a sensing signal generated by an automobile obstacle recognition system consists of sensors. The vibration of the seat is used to warn the danger, and the obstacle orientation is accurately indicated by the partitioned vibration.

In the above usage scenarios, the multi-channel vehicle-mounted seat vibration feedback system 100 of the present disclosure may assist the user in performing safety driving or danger warning through tactile sensation in the case of visual and auditory deficiency, enhance the distinguishing of information prompt, reduce the learning cost of the user, and thus improving road driving safety.

Second, an effect generated by the multi-channel vehicle-mounted seat vibration feedback system 100 may be to transmit multimedia information to a driver through seat vibration and sound:

In the case of playing music in an automobile, the interaction signal is the audio data of the music. Different audio data may be processed by the signal processing module 102, and the specific preset machine learning algorithm is called to obtain the audio data having different features (such as voice and different musical instruments). After processing the audio data according to certain rules, the multi-channel vibration and audio signals having different music features in different signal channels are obtained by the multi-channel data processing module 103. The different motors in the vehicle-mounted seat may work independently after receiving the driving signals, thereby achieving the three-dimensional tactile effect of distinguishing content. In addition, it plays synchronously with music to improve the three-dimensional sense, rhythm and richness of music.

In the scenario of playing audio and video in an automobile, the interaction signal is video stream data of the audio and video. Because the video stream includes both audio and video, the video stream data may be processed by the signal processing module 102 by calling a specific preset machine learning algorithm, so as to obtain the pending signals including different sound characteristics and vibration characteristics. Then, the multi-channel signals including different vibration data and audio data in different signal channels are obtained by the multi-channel data processing module 103. The different vibration motors and speakers in the vehicle-mounted seat may work independently after receiving the driving signals, thereby achieving the stereoscopic vibration and surrounded stereo sounding effects of distinguishing content;

In the above usage scenarios, the signal processing module 102 performs processing based on the preset machine learning algorithm, different events such as automobile roar and object collision are identified from audio and video data. For different events identified, event features such as sound spectrum and time domain envelope may be analyzed in real time, and corresponding vibration signals may be generated according to the preset tactile generation strategy in the algorithm. The vibration signals corresponding to the events may also be retrieved from the effect library according to the preset strategy, and the vibration signals may be processed according to the event characteristics.

In the scenario of playing games in an automobile, the interaction signal is game data. The difference between game data and audio is that in addition to containing all in-game audio and video data, it may also contain a variety of signals input through the controller. Similarly, these data may be processed by the signal processing module 102, a specific preset tactile generation strategy or machine learning algorithm is called to obtain the pending signals including different sound features and vibration features. Then, the multi-channel signals including different vibration data and audio data in different signal channels are obtained by the multi-channel data processing module 103. Different vibration motors and speakers in the vehicle-mounted seat may work independently after receiving the driving signals, which may achieve a more stunning game experience.

In the above usage scenarios, the signal processing module 102 dynamically adjusts the vibration signals in real time according to the interaction parameters in the game, and the control dimension of the vibration signals includes but is not limited to: intensity, frequency, envelope curve, etc.

In addition, in embodiments of the present disclosure, each of the multi-channel data corresponds to at least one of the feedback output channels, and each of the tactile feedback output channels corresponds to an individual vibration motor or speaker of the automobile seat, so that a vibration signal correspondingly generated by each interaction signal may be divided into a plurality of vibration files according to actual needs. A vibration signal corresponding to each interaction event may be allocated to one or more vibration motors, thereby achieving a better vibration or sounding effect according to characteristics of different vehicle-mounted seats.

Compared with the related art, the present disclosure, a multi-channel vehicle-mounted seat vibration feedback system includes a signal input module which is used for obtaining at least one interaction signal collected or output by an automobile system; a signal processing module which is used for performing data stream conversion on each interaction signal to obtain a corresponding pending signal; a multi-channel data processing module which is used for preprocessing the pending signal according to a preset signal processing method to obtain a multi-channel signal; a driving module which is used for outputting a driving signal used for driving the vibration and/or sound of the automobile seat through at least one feedback output channel according to the multi-channel signal; and an execution module which is used for driving the vibration and/or sound of the automobile seat according to the driving signal of each individual tactile feedback and audio output channel. Based on the characteristics of the multifunctional automobile seat, multi-channel driving signals are generated for different interaction scenarios between the automobile and drivers and passengers, and the vibration and sound production control of the multifunctional automobile seat is implemented in a mode of independently controlling an output channel, so that the effect of feeding back the signals to the drivers and the passengers is more accurate and richer, and thus the use experience is improved.

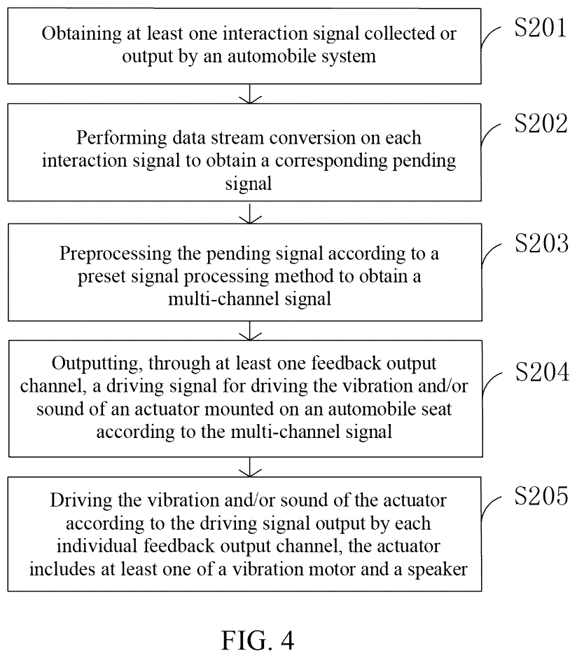

The present disclosure further provides a multi-channel vehicle-mounted seat vibration feedback method, as shown in FIG. 4, FIG. 4 is a schematic flowchart of steps of a multi-channel vehicle-mounted seat vibration feedback method according to an embodiment of the present disclosure. The multi-channel vehicle-mounted seat vibration feedback method includes the following steps.

201: obtaining at least one interaction signal collected or output by an automobile system.

202: performing data stream conversion on each interaction signal to obtain a corresponding pending signal.

203: preprocessing the pending signal according to a preset signal processing method to obtain a multi-channel signal.

204: outputting a driving signal for driving the vibration and/or sound of an actuator mounted on an automobile seat through at least one feedback output channel according to the multi-channel signal.

205: driving the vibration and/or sound of the actuator according to the driving signal output by each individual feedback output channel.

The actuator includes at least one of a vibration motor and a speaker.

The multi-channel vehicle-mounted seat vibration feedback method may be implemented based on the multi-channel vehicle-mounted seat vibration feedback system 100 described above, and may achieve the same technical effects, which will not be repeated herein.

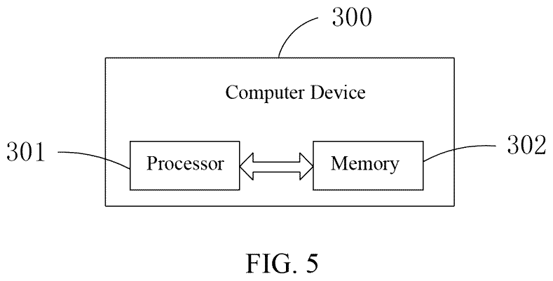

Embodiments of the present disclosure also provide a computer device, referring to FIG. 5, FIG. 5 is a schematic structural diagram of a computer device according to an embodiment of the present disclosure. The computer device 300 includes: a memory 302, a processor 301, and a multi-channel vehicle-mounted seat vibration feedback program stored on the memory 302 and executable on the processor 301.

Referring to FIG. 4, the processor 301 calls the multi-channel vehicle-mounted seat vibration feedback program stored in the memory 302 to perform the steps in the multi-channel vehicle-mounted seat vibration feedback method provided in the above embodiments, which includes the following steps:

201: obtaining at least one interaction signal collected or output by an automobile system.

202: performing data stream conversion on each interaction signal to obtain a corresponding pending signal.

203: preprocessing the pending signal according to a preset signal processing method to obtain a multi-channel signal.

204: outputting a driving signal for driving the vibration and/or sound of an actuator mounted on an automobile seat through at least one feedback output channel according to the multi-channel signal, and each driving signal individually corresponds to each interaction signal.

205: driving the vibration and/or sound of the actuator according to the driving signal output by each individual feedback output channel.

The actuator includes at least one of a vibration motor and a speaker.

The computer device 300 provided in the present disclosure may implement the steps in the multi-channel vehicle-mounted seat vibration feedback method in the above embodiments, and may achieve the same technical effects, which will not be repeated herein.

Embodiments of the present disclosure further provide a computer-readable storage medium, a multi-channel vehicle-mounted seat vibration feedback program is stored on the computer-readable storage medium, and when the multi-channel vehicle-mounted seat vibration feedback program is executed by a processor, processes and steps of the multi-channel vehicle-mounted seat vibration feedback method as provided by the above embodiments are implemented, and may achieve the same technical effects, which will not be repeated herein.

Those skilled in the art may understand that all or part of the processes in the above embodiments may be implemented by using a computer program to instruct related hardware, the program may be stored in a computer-readable storage medium, and when the program is executed, it may include the processes according to the above embodiments. The storage medium may be a magnetic disk, an optical disk, a read-only memory (ROM), a random access memory (RAM), etc.

It should be noted that, in the text, terms such as “include”, “comprise” or any other variants are meant to cover non-exclusive enclosure, so that the process, method, item or device comprising a series of elements not only include the elements but also include other elements which are not specifically listed or the inherent elements of the process, method, item or device. Without more specific limitations, an element defined by the statement “including one” does not preclude the presence of another identical element in a process, method, article, or apparatus that includes the element.

Through the description of the above embodiments, those skilled in the art may clearly understand that the method of the above embodiments may be implemented by means of software plus a necessary universal hardware platform, and may also be implemented by hardware, but the former is a better embodiment in many cases. Based on such understanding, the technical solution of the present disclosure essentially or the part contributing to the related art may be embodied in the form of a software product, and the computer software product is stored in a storage medium (such as ROM/RAM, a magnetic disk, or an optical disk), and includes several instructions for enabling a terminal (which may be a mobile phone, a computer, a server, an air conditioner, or a network device) to execute the method described in the embodiments of the present disclosure.

The above description only refers to some embodiments of the present disclosure, and it should be noted that those skilled in the art may further make improvements without departing from the concept of the present disclosure, but these all fall within the protection scope of the present disclosure.

What is claimed is:

1. A multi-channel vehicle-mounted seat vibration feedback system, comprising:
a signal input module, configured to obtain at least one interaction signal collected or output by an automobile system;
a signal processing module, configured to perform data stream conversion on each interaction signal to obtain a corresponding pending signal;
a multi-channel data processing module, configured to preprocess the pending signal according to a preset signal processing method to obtain a multi-channel signal;
a driving module, configured to output, through at least one feedback output channel, a driving signal for driving vibration and/or sound of an actuator mounted on an automobile seat according to the multi-channel signal; and
an execution module, configured to drive the vibration and/or sound of the actuator according to the driving signal output by each individual feedback output channel,
wherein the actuator is at least one of a vibration motor and a speaker.

2. The multi-channel vehicle-mounted seat vibration feedback system as described in claim 1, wherein the signal processing module is further configured to:
identify and analyze the interaction signal by using a preset machine learning algorithm, and separate a single interaction signal into a plurality of signals having different features, each of the signals having different features is used as a new interaction signal to perform data stream conversion processing.

3. The multi-channel vehicle-mounted seat vibration feedback system as described in claim 1, wherein the multi-channel data processing module is configured to:
allocate the pending signal corresponding to the interaction signal to different signal channels according to preset interactive scenarios corresponding to different interaction signals, to obtain the multi-channel signal.

4. The multi-channel vehicle-mounted seat vibration feedback system as described in claim 3, wherein each of the signal channels corresponds to at least one of the feedback output channels, and each of the feedback output channels corresponds to an individual actuator of the automobile seat.

5. The multi-channel vehicle-mounted seat vibration feedback system as described in claim 1, wherein the driving module is further configured to:
perform digital amplification processing on the driving signal according to vibration acoustic characteristics of the automobile seat.

6. The multi-channel vehicle-mounted seat vibration feedback system as described in claim 1, wherein the preset signal processing method comprises at least one of signal sampling, signal encoding and decoding, signal noise reduction, signal filtering, and calling from a preset database according to signal type.

7. The multi-channel vehicle-mounted seat vibration feedback system as described in claim 2, wherein the preset machine learning algorithm comprises at least one of a sound feature extraction and classification algorithm, an image feature extraction and classification algorithm, a sound-based supervised and unsupervised machine learning algorithm, and an image-based supervised and unsupervised machine learning algorithm.

8. A multi-channel vehicle-mounted seat vibration feedback method, comprising:
obtaining at least one interaction signal collected or output by an automobile system;
performing data stream conversion on each interaction signal to obtain a corresponding pending signal;
preprocessing the pending signal according to a preset signal processing method to obtain a multi-channel signal;
outputting, through at least one feedback output channel, a driving signal for driving the vibration and/or sound of an actuator mounted on an automobile seat according to the multi-channel signal; and
driving the vibration and/or sound of the actuator according to the driving signal output by each individual feedback output channel,
wherein the actuator includes at least one of a vibration motor and a speaker.

9. A non-transitory computer-readable storage medium, wherein a multi-channel vehicle-mounted seat vibration feedback program is stored on the computer-readable storage medium, and when the multi-channel vehicle-mounted seat vibration feedback program is executed by a processor, steps of the multi-channel vehicle-mounted seat vibration feedback method as described in claim 8 are implemented.
